(19) United States
(12) Patent Application Publication
(10) Pub. No.: US 2014/0317651 A1
(43) Pub. Date: Oct. 23, 2014

(54) ELECTRONIC DEVICE, INFORMATION PROCESSING METHOD, AND INFORMATION PROCESSING PROGRAM

(71) Applicant: Kabushiki Kaisha Toshiba, Tokyo (JP)

(72) Inventors: Yoko Masuo, Iruma-shi (JP); Shunji Ui, Ome-shi (JP); Takanori Yamaguchi, Hamura-shi (JP)

(73) Assignee: Kabushiki Kaisha Toshiba, Tokyo (JP)

(21) Appl. No.: 14/034,454

(22) Filed: Sep. 23, 2013

(30) Foreign Application Priority Data
Apr. 18, 2013 (JP) 2013-087519

(51) Int. Cl. H04N 21/454

(52) U.S. Cl. CPC H04N 21/454
USPC 725/29

(57) ABSTRACT

According to one embodiment, the purpose of this invention is to provide an electronic device which can output information in accordance with a schedule of each person. The electronic device of the embodiments has a manager, an identifier, and a controller. The manager manages a schedule corresponding to personal identification information. The identifier identifies the personal identification information from input information. The controller controls output of schedule-related information regarding the schedule corresponding to the identified personal identification information and output of content.

### CROSS-REFERENCE TO RELATED APPLICATIONS

This application is based upon and claims the benefit of priority from Japanese Patent Application No. 2013-087519, filed Apr. 18, 2013, the entire contents of which are incorporated herein by reference.

### FIELD

Embodiments described herein relate generally to an electronic device, an information processing method, and an information processing program.

### BACKGROUND

Users of electronic devices such as a digital TV are able to enjoy various items of content thereon. The users sometimes get carried away in watching content and continue watching it beyond a scheduled time. Using an alarm or the like is supposed to be one of preventive measures against such an inconvenience or a miss.

However, an action pattern of a person varies depending on a day or hours and setting an alarm for every specific schedule is an annoying task. The action pattern also varies user by user. Thus, using an alarm does not prevent the above-described inconvenience or miss effectively.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a block diagram illustrating a schematic configuration of a content player (electronic device) of a first embodiment;

FIG. 2 is a flowchart illustrating an example of schedule notification of the first embodiment;

FIG. 3 is a diagram illustrating an example of a schedule database stored in a schedule database of the first embodiment;

FIG. 4A is a diagram illustrating an output example of an additional information of the first embodiment;

FIG. 4B is a diagram illustrating an output example of additional information of a second embodiment;

FIG. 5 is a block diagram illustrating a schematic configuration of a content player (electronic device) of the second embodiment;

FIG. 6 is a block diagram illustrating an example of a schematic configuration of an information processing system of a third embodiment; and

FIG. 7 is a diagram illustrating an example of an initial setting screen of the schedule notification of the first embodiment.

### DETAILED DESCRIPTION

Various embodiments will be described hereinafter with reference to the accompanying drawings.

In general, according to one embodiment, there are provided an electronic device, an information processing method, and an information processing program with which information according to a schedule of each user can be output.

According to an embodiment of the present disclosure, the electronic device has a manager, an identifier, and a controller. The manager manages a schedule corresponding to a piece of personal identification information. The identifier identifies the personal identification information from input information. The controller controls output of schedule-related information relevant to the schedule corresponding to the identified personal identification information and output of content.

An embodiment will further be described with reference to the drawings.

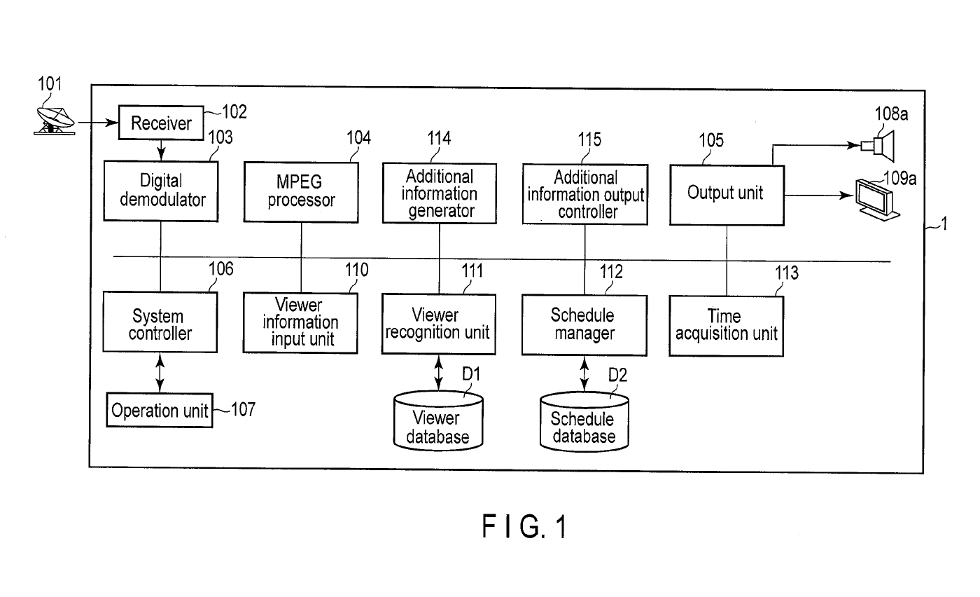

FIG. 1 is a block diagram illustrating a schematic configuration of a content player (electronic device) of a first embodiment. The content player 1 is, for example, a digital TV which is able to receive and play broadcast content. The digital TV is, without being limited to broadcast content, also able to receive and play network-delivered content, replay recorded content recorded on a hard disk or the like, record broadcast content on a hard disk or the like. The content player 1 shown in FIG. 1 may also be a media player which replays content stored on various media. Further, the content player 1 may be a digital recorder which is able to record and replay various items of content. That is, any electronic device that has a content playback function, for example, a mobile terminal, can be used for the content player 1. The description below will be done assuming the content player 1 is a digital TV.

As shown in FIG. 1, the content player 1 has a receiver 102, a digital demodulator 103, an MPEG processor 104, an output unit 105, a system controller 106, an operation unit 107, a speaker 108, a display 109, a viewer information input unit 110, a viewer recognition unit 111, a schedule manager 112, a time acquisition unit 113, an additional information generator 114, an additional information output controller 115, an viewer database D1, and a schedule database D2.

The receiver 102 receives a broadcast signal from an antenna 101, converts it into an intermediate frequency (IF) signal, and outputs the IF signal to the digital demodulator 103. The digital demodulator 103 extracts a digital signal (Transport Stream (TS)) from the IF signal and outputs the TS to the MPEG processor 104. The MPEG processor 104 separates the TS into image data, sound data, and Service Information (SI) for EPG display and decodes the image and sound data. The output unit 105 outputs the decoded image and sound data to the display 109 and the speaker 108. The display 109 displays an image based on the image data. The speaker 108 outputs a sound based on the sound data.

The system controller 106 is a processing unit to control operation of every unit integrally. The system controller 106, for example, receives an input (control command) from the operation unit 107 and integrally controls operation of each unit according to the input. The operation unit 107 may, for example, be a remote controller or an information communication terminal such as a tablet PC and a smart phone. The control command, for example, is a command for directing to play a television broadcast (broadcast content), a command for directing to record content, or a command for directing to replay recorded content.

The viewer information input unit 110 may be a camera to capture an image of a viewer, such as a camera disclosed in Japanese Patent Application Publication No. 2007-081677, or a remote controller possessing a personal identification function (a remote controller which output a personal identification ID), such as a remote controller disclosed in Japanese Patent Application Publication No. H08-009282. The viewer information input unit 110 may also be a scanner for scanning a fingerprint of a viewer or a communication unit for receiving terminal identification information or a personal identification ID from an information communication terminal such as a tablet PC and a smart phone.

If the viewer information input unit 110 is a camera, the viewer information input unit 110 inputs a captured image (biometric information) as input information. If the viewer information input unit 110 is a remote controller, the viewer information input unit 110 inputs a personal identification ID or the like as the input information. If the viewer information input unit 110 is a scanner, the viewer information input unit 110 scans a fingerprint of a viewer and inputs the scanned fingerprint information as the input information. If the viewer information input unit 110 is a communication unit, the viewer information input unit 110 inputs terminal identification information, a personal identification ID or the like as the input information.

If the viewer information input unit 110 is a camera, for example, the viewer database D1 stores characteristic information (biometric information), which is a facial characteristic quantity extracted from the captured image of the viewer, and a personal identification ID (personal identification information) in advance (advance registration). That is, the viewer database D1 stores (advance registration) the characteristic information corresponding to the personal identification ID. With this configuration, it is possible to identify the registered personal identification ID corresponding to (the characteristic information of) the viewer, which is input through the viewer information input unit 110, based on the viewer database D1. More specifically, the viewer information input unit 110 outputs the captured image to the viewer recognition unit 111. The viewer recognition unit 111 recognizes a facial image of the viewer from the captured image and analyzes the characteristic information, which is a facial characteristic quantity extracted from the facial image of the viewer. The viewer recognition unit 111 identifies the viewer through comparing the extracted characteristic information with the characteristic information stored (advance registration) in the viewer database D1. That is, the viewer recognition unit 111 is able to identify the viewer by identifying the personal identification ID corresponding to the viewer.

If the viewer information input unit 110 is a remote controller, the viewer database D1 stores at least the personal identification ID (advance registration). With this configuration, it is possible to determine whether the personal identification ID of the viewer, input via the viewer information input unit 110, has been registered or not based on the viewer database D1.

If the viewer information input unit 110 is a scanner, the viewer database D1 stores characteristic information (biometric information), which is a fingerprint characteristic quantity extracted from the fingerprint of the viewer, and the personal identification ID (personal identification information) in advance (advance registration). That is, the viewer database D1 stores (advance registration) the characteristic information corresponding to the personal identification ID. With this configuration, it is possible to identify the registered personal identification ID corresponding to (the characteristic information of) the viewer, which is input through the viewer information input unit 110, based on the viewer database D1.

If the viewer information input unit 110 is a communication unit, the viewer database D1 stores (advance registration) terminal identification information corresponding to the personal identification ID. Alternatively, the viewer database D1 stores the personal identification ID. With this configuration, it is possible to identify the registered personal identification ID corresponding to the terminal identification information, which is input through the viewer information input unit 110, based on the viewer database D1. Alternatively, it is possible to determine whether the personal identification ID of the viewer, input via the viewer information input unit 110, has been registered or not based on the viewer database D1.

The schedule manager 112 receives schedule information for every person (for every personal identification ID) from the operation unit 107 and the schedule database D2 stores the received schedule information and the personal identification ID. That is, the schedule database D2 stores the schedule information corresponding to the personal identification ID. The schedule information includes, for example, at least time information (or date and time information). The schedule information may also include area information in addition to the time information (or date and time information).

Alternatively, the schedule manager 112 may receive the schedule information for every person (for every personal identification ID) from an information communication terminal such as a tablet PC and a smart phone via a network.

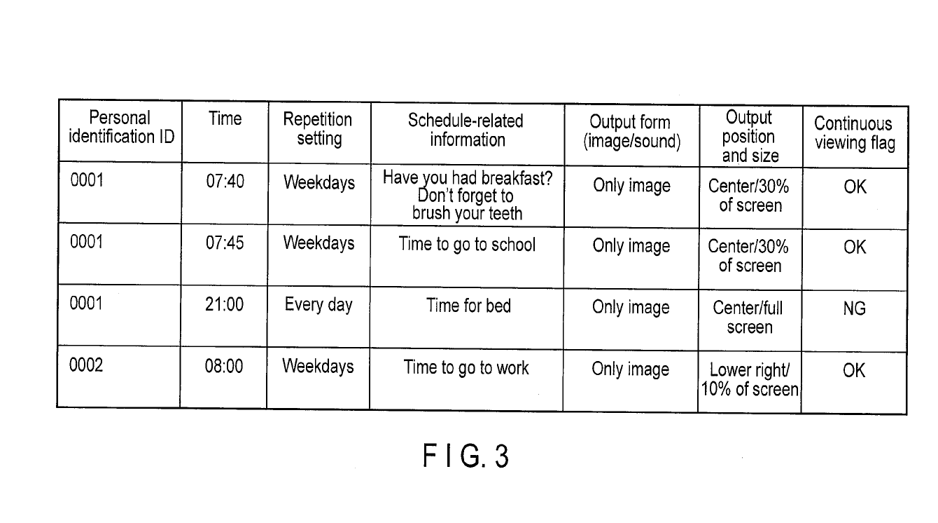

FIG. 3 is a diagram illustrating an example of a schedule database stored in the schedule database D2. The schedule database manages the schedule information for every person (for every personal identification ID). The schedule information includes, for example, time information, a repetition setting, schedule-related information, an output form (image/sound), an output position and size, and a continuous viewing flag (content output limit information).

The schedule manager 112 receives the personal identification ID of the viewer recognized through the viewer recognition unit 111 and current time acquired through the time acquisition unit 113 and confirms whether or not the schedule information corresponding to the received personal identification ID and the current time is registered.

For example, if the schedule manager 112 receives a personal identification ID (0001/user A) identified through the viewer recognition unit 111 and current time (07:45) and confirms that schedule information corresponding to the personal identification ID (0001/user A) and the current time (07:45) is registered while the system controller 106 controls content play (i.e., detecting that content is played), the system controller 106 directs the additional information output controller 115 to output schedule-related information contained in the schedule information (for example, “It's time to go to school”).

The additional information output controller 115 directs the additional information generator 114 to generate additional information in an image or sound form based on the schedule-related information, output form, and output position and size contained in the schedule information stored in the schedule database D2. The additional information generator 114 generates the additional information in an image or sound form based on the schedule-related information, output form, and output position and size contained in the schedule information stored in the schedule database D2. The output unit 105 outputs the generated additional information by combining it with images or sounds of original content.

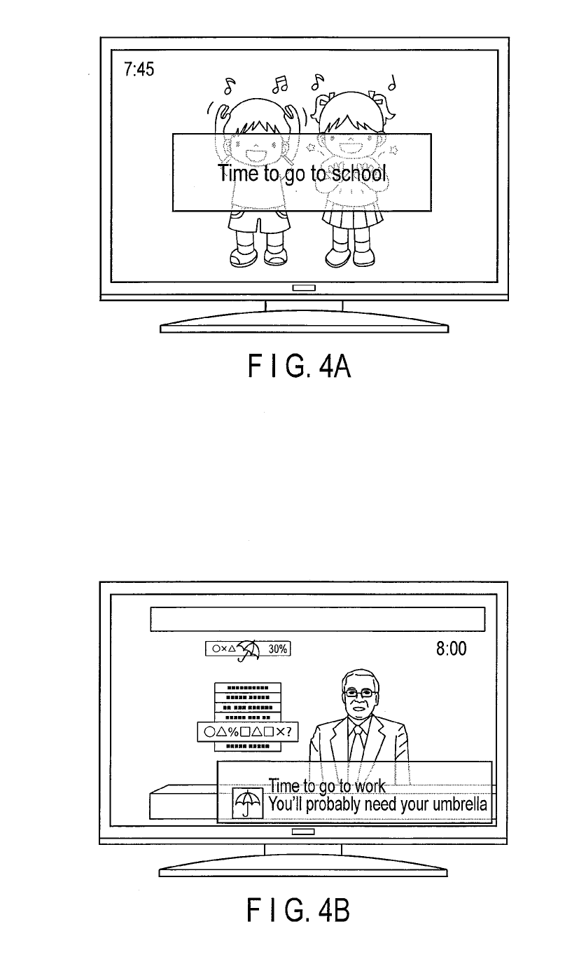

For example, the additional information output controller 115 directs the additional information generator 114 to generate additional information based on the schedule-related information (It's time to go to school.), output form (image), and output position and size (center/30% of screen), which are contained in the schedule information. The additional information generator 114 generates the additional information based on the schedule-related information (It's time to go to school.), output form (image), and output position and size (center/30% of screen). The additional information output controller 115 controls output timing of the additional information based on the time (07:45) contained in the schedule information. The output unit 105 outputs the generated additional information by combining it with images or sounds of original contents at the output timing (07:45) controlled by the additional information output controller 115. By this process, the display 109a, for example, displays the combined image shown in FIG. 4A for a predefined duration from the time (07:45) contained in the schedule information.

The additional information including the user name A can also be output by adding the user name A to the schedule-related information.

The system controller 106 controls the contents play based on the continuous viewing flag contained in the schedule information. For example, when the combined image shown in FIG. 4A has been displayed for a predefined amount of time, the system controller 106 continues the contents play based on the continuous viewing flag (OK) contained in the schedule information.

Another example is that if the schedule manager 112 receives a personal identification ID (0002/User B) identified by the viewer recognition unit 111 and confirms that schedule information corresponding to the personal identification ID (0002/User B) and the current time (08:00) has been registered while the system controller 106 is controlling the contents play, the system controller 106 directs the additional information output controller 115 to output schedule-related information (8:00. It's time to go to work. You'll probably need your umbrella.) contained in the schedule information.

For example, the additional information output controller 115 directs the additional information generator 114 to generate additional information based on the schedule-related information (8:00. It's time to go to work. You'll probably need umbrella.), output form (image), and output position and size (lower right/10% of screen), which are contained in the schedule information. The additional information generator 114 generates the additional information based on the schedule-related information (8:00. It's time to go to work. You'll probably need your umbrella.), output form (image), and output position and size (lower right/10% of screen). The additional information output controller 115 controls output timing of the additional information based on the time (08:00) contained in the schedule information. The output unit 105 outputs the generated additional information at the output timing (08:00) controlled by the additional information output controller 115 by combining it with images or sounds of the original (content). By this process, the display 109, for example, displays the combined image shown in FIG. 4B for predefined duration from the time (08:00) contained in the schedule information.

The additional information including the user name B can also be output (displayed) by adding the user name B to the schedule-related information.

The system controller 106 controls content play based on the continuous viewing flag contained in the schedule information. For example, when the combined image shown in FIG. 4B has been displayed for a predefined amount of time, the system controller 106 continues content play based on the continuous viewing flag (OK) contained in the schedule information.

By the above-described configuration, it becomes possible to notify the viewer of the schedule-related information in an easy-to-understand form when the viewer is viewing content at the time (scheduled time) at which the viewer, who is related to the schedule, has a plan.

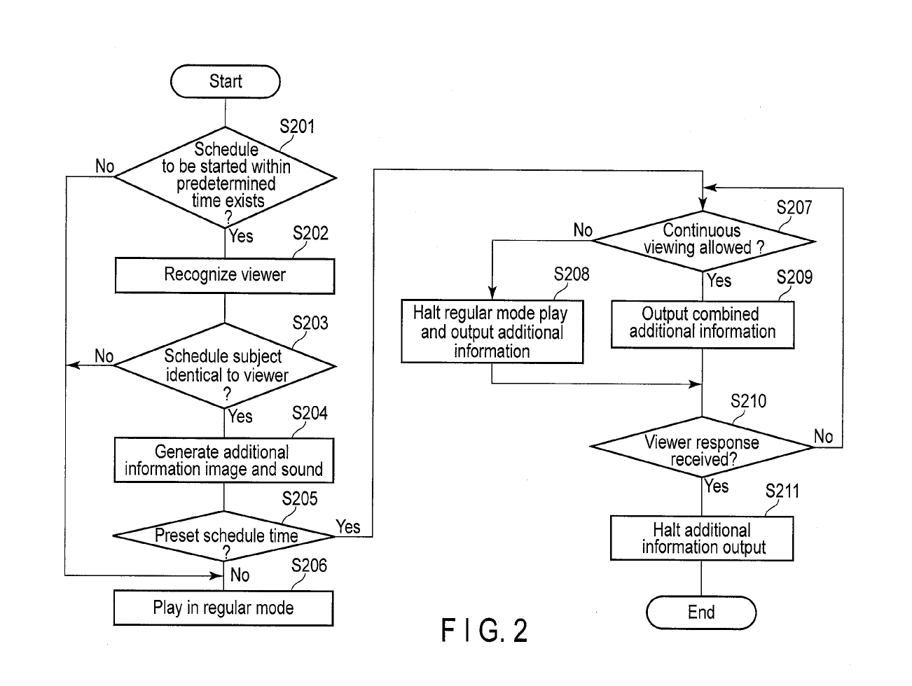

FIG. 2 is a flowchart illustrating an example of schedule information according to the first embodiment.

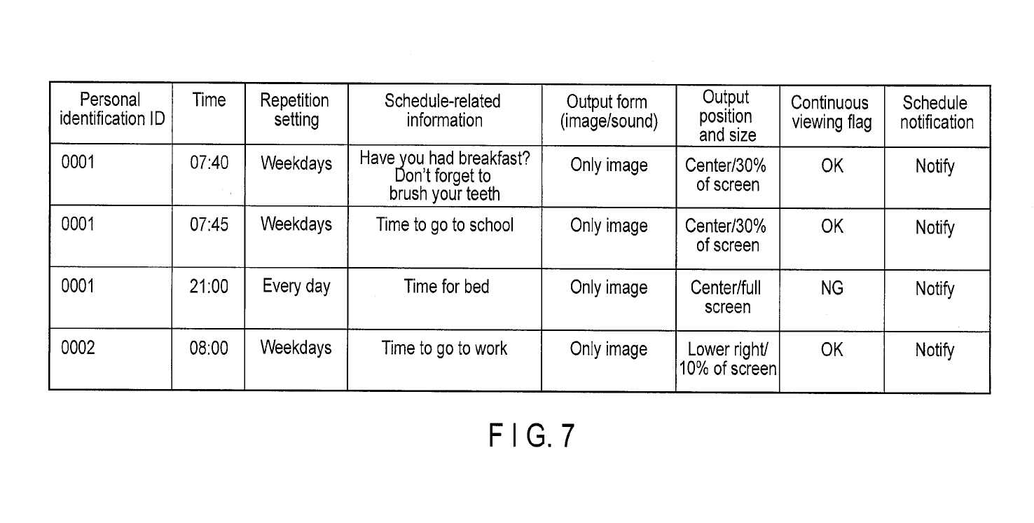

The example shows the system controller 106 manages setting information of schedule notification and controls an execution of the schedule notification according to the setting information. FIG. 7 is a diagram illustrating an example of an initial setting screen of the schedule notification. A user can, for example, set whether or not to notify a schedule to the initial setting screen via the operation unit 107. A case in which the notification of all schedule is set will be described below.

The schedule manager 112 checks if a schedule to be started within a predetermined timeframe from the current time is registered (S201) in the schedule database D2 while the system controller 106 controls content play (during detection of content play). If no schedule to be started within the predetermined timeframe from the current time is registered (No in S201), the system controller 106 continues the content play (S206).

If a schedule to be started within the predetermined timeframe from the current time is registered (Yes in S201), the schedule information of the schedule containing time information (07:45) is, for example, registered in the schedule database shown in FIG. 3. When the time comes to a point ahead of the time defined in the time information (07:45), the viewer recognition unit 111 recognizes the viewer (S202), identifies the personal identification ID corresponding to the viewer, and notifies the schedule manager 112 of the identified personal identification ID.

The schedule manager 112 compares the personal identification ID contained in the schedule information including the time information (07:45) with the received personal identification ID. If the personal identification ID contained in the schedule information including the time information (07:45) is not identical to the received personal identification ID, i.e. a subject of the schedule and the viewer are not identical (No in S203), the system controller 107 continues the content play (S206). If the subject of the schedule and the viewer are identical (Yes in S203), the schedule manager 112 directs the additional information output controller 115 to output the schedule-related information (It's time to go to school.) contained in the schedule information and the additional information generator 114 generates an additional information image (or additional information sound) based on the schedule-related information (It's time to go to school.) or the like contained in the schedule information (S204).

If the time does not come to the point defined by the time information (07:45) contained in the schedule information (No in S205), the content play continues (S206). If the time comes to the point defined by the time information (07:45) contained in the schedule information (Yes in S205) and the continuous viewing flag contained in the schedule information shows that continuous viewing is allowed (Yes in S207), the output unit 105 outputs the generated additional information by combining it with images or sounds of the original (content) under the control of the additional information output controller 115 (S209). If the continuous play is not allowed by the continuous viewing flag contained in the schedule information (No in S207), the system controller 106 stops the content play and the output unit 105 outputs the generated additional information under the control of the additional information output controller 115 (S208).

The processes in S207, 5208, and S209 are repeated until the system controller 106 detects a response from the viewer through the operation unit 107, the schedule manager 112 detects an inconsistency between the subject of the schedule and the viewer, or the schedule manager 112 detects a scheduled time of another new schedule.

If the system controller 106 detects a response from the viewer through the operation unit 107 (Yes in S210), the schedule manager 112 detects an inconsistency between the subject of the schedule and the viewer, or the schedule manager 112 detects a scheduled time of another new schedule, the additional information output controller 115 stops outputting the additional information (S211) and the process proceeds to the content play or the notification processing of a next schedule. Another processing corresponding to the response by the viewer may be started.

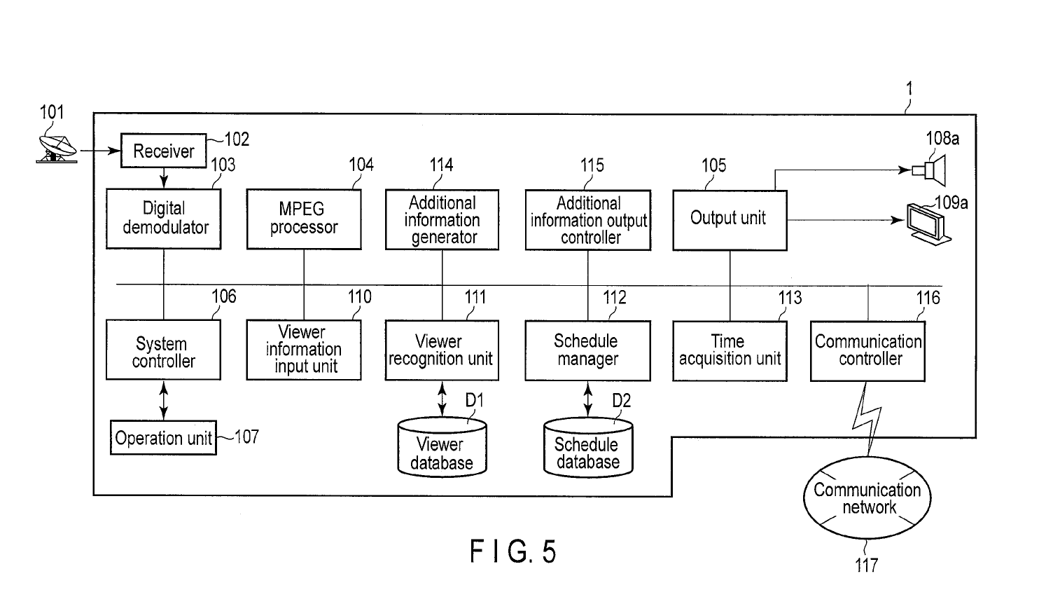

FIG. 5 is a block diagram illustrating a schematic configuration of a content player (electronic device) of a second embodiment. The content player 1 shown in FIG. 5 may be an electronic device such as a digital TV, digital player, and digital recorder. Because the content player 1 of the second embodiment and the content player 1 of the first embodiment have many same features, only the features of the content player 1 according to the second embodiment that are different from the corresponding features of the content player 1 according to the first embodiment will be focused.

As shown in FIG. 5, the content player 1 according to the second embodiment has a communication controller 116.

The communication controller 116 receives weather information (meteorology information), traffic information or the like via a communication network 117. A receiver 102 may receive the weather information (meteorology information), traffic information or the like from a broadcast signal. The weather information includes date and time information (April 20) and area information (Tokyo). Similarly, the traffic information includes the date and time information (April 20) and the area information (Tokyo).

If the schedule information in the schedule database D2 contains the date and time information and area information, it becomes possible for the content player 1 to output (display) the weather information and traffic information corresponding to a schedule by using the date and time information and area information contained in the received weather information and traffic information. That is, it becomes possible to output (display) the weather information and traffic information corresponding to the schedule together with schedule-related information.

An additional information output controller 115 of the content player 1 can, for example, suggest a necessity of rain gears together with the schedule-related information based on schedule information including the date and time information (April 20) and area information (Tokyo) and the weather information (rain) including the date and time information (April 20) and area information (Tokyo). The additional information output controller 115 of the content player 1 can also suggest a necessity of an outfit for cold weather together with the schedule-related information based on the schedule information including the date and time information (April 20) and area information (Tokyo) and the weather information (the highest temperature is 5° C.) including the date and time information (April 20) and area information (Tokyo). The content player 1 can thus supply a viewer with more beneficial information.

The communication controller 116 can also communicate with an information communication terminal such as a tablet PC and smart phone directly or indirectly via the communication network 117. A schedule database D2 stores at least one type of address information, i.e. mail address, phone number, or the like, of the information communication terminal. That is, the schedule database D2 stores (advance registration) a personal identification ID, the schedule information, and the address information with relations among them.

By the above-described configuration, the communication controller 116 can transmit additional information to the address information based on the schedule database D2. For example, the content player 1 can find a personal identification ID (0001/User A) and output (display on a display 109) the additional information at an additional information output timing corresponding to the personal identification ID (0001/User A). The content player 1 can also output (transmit) the additional information to an address indicated in the address information corresponding to the personal identification ID (0001/User A). Moreover, the content player 1, with identifying the personal identification ID (0001/User A) and outputting (displaying on the display 109) the additional information at the additional information output timing corresponding to the personal identification ID (0001/User A), can also output (transmit) the additional information to an address indicated in an address information corresponding to a personal identification ID (0002/user B). Furthermore, the content player 1, with identifying the personal identification ID (0001/User A) and outputting (displaying on the display 109) the additional information at the additional information output timing corresponding to the personal identification ID (0001/User A), can also output (transmit) the additional information to the address indicated in the address information corresponding to the personal identification ID (0001/user A) and the address indicated in the address information corresponding to the personal identification ID (0002/user B).

By the above-described configuration, if the personal identification ID (0001/User A) is not identified or the viewer with the personal identification ID (0001/User A) is not identified at the additional information output timing corresponding to the personal identification ID (0001/User A), the content player 1 can also output (transmit) the additional information to the address indicated in the address information corresponding to the personal identification ID (0001/User A). Moreover, if the personal identification ID (0001/User A) is not identified or the viewer with the personal identification ID (0001/User A) is not identified at the additional information output timing corresponding to the personal identification ID (0001/User A), the content player 1 can also output (transmit) the additional information to the address indicated in the address information corresponding to the personal identification ID (0002/User B). Furthermore, if the personal identification ID (0001/User A) is not identified or the viewer with the personal identification ID (0001/User A) is not identified at the additional information output timing corresponding to the personal identification ID (0001/User A), the content player 1 can also output (transmit) the additional information to the address indicated in the address information corresponding to the personal identification ID (0001/User A) and the address indicated in the address information corresponding to the personal identification ID (0002/User B).

If a system controller 106 determines that there is no appropriate response (for example, an operation to halt content play) to a notification of the additional information (schedule notification) from a viewer (for example, a child), the communication controller 116 may communicate to the address in designated address information (address information of his/her parent) that there is no appropriate response. By this function, if, for example, a child ignores the message “Time to do your homework” and continue viewing content, it is possible to send to his/her parent a mail message indicating that content viewing is continued. Even if the parents are not close to the content player 1, the parents are able to monitor behavior of their children and it becomes easier for children to keep to their schedule. The content player 1 of the second embodiment can be used for the purpose of monitoring grandparents who is living in a remote place.

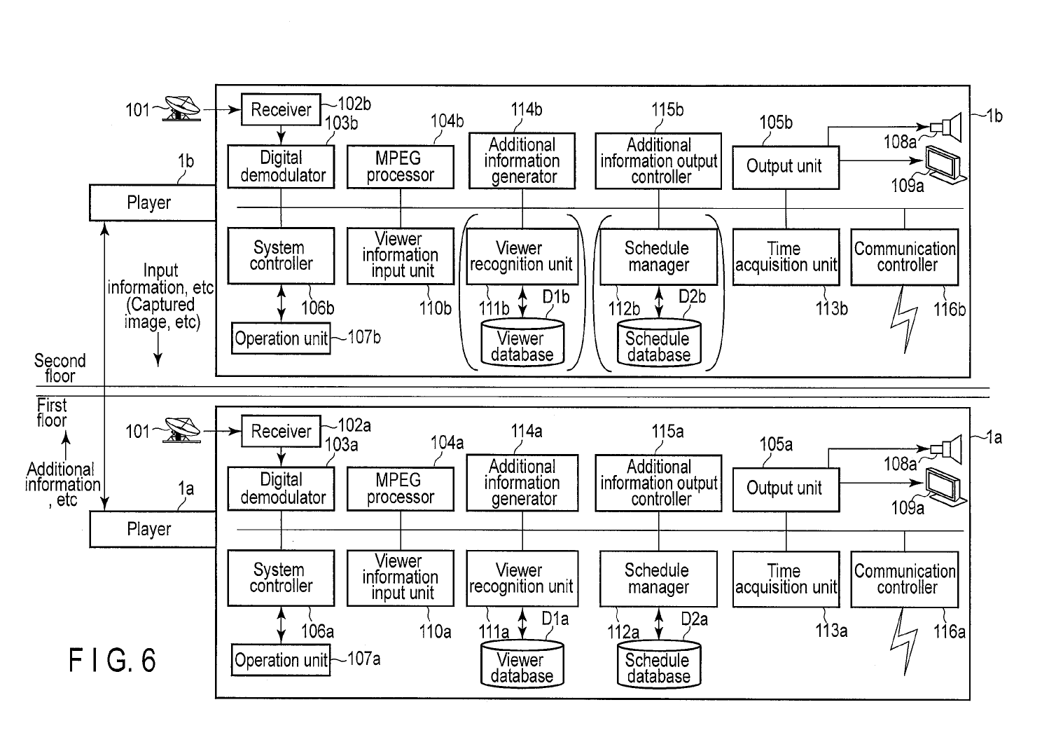

FIG. 6 is a block diagram of an example of schematic configuration of an information processing system of a third embodiment. The information processing system shown in FIG. 6 can be configured by connecting a plurality of the content players via a network. With the purpose of clear description, a case in which content players 1a and 1b are connected via the network is described. For example, the content player 1a is installed on a first floor and the content player 1b on a second floor.

The content players 1a and 1b can have the same configuration as the content player 1 shown in FIG. 5. If the content player 1a has the same configuration as the content player 1b, data stored in a viewer database D1a and a schedule database D2a in the content player 1a and data stored in a viewer database D1b and a schedule database D2b in the content player 1b are identical. That is, the data in the viewer database D1a and the schedule database D2a and the data in the viewer database D1b and the schedule database D2b are synchronized regularly.

The configuration of the content player 1b may be simplified. For example, a viewer recognition unit 111b, a schedule manager 112b, the viewer database D1b, the schedule database D2b, and an additional information generator 114b may be omitted from the configuration of the content player 1b (refer to FIG. 6). In this case, a viewer recognition unit 111a of the content player 1a recognizes a viewer based on the viewer database D1a (identifies a personal identification ID of the viewer) and a schedule manager 112a of the content player 1a reads out schedule information corresponding to the identified personal identification ID based on the schedule database D2.

An example of schedule notification by the content player 1a and the simplified content player 1b will be described below. When a child, for example, views content with the content player 1b installed on the second floor, i.e. when a system controller 106b of the content player 1b is controlling content play (during detection of the content play), a communication controller 116b of the content player 1b transmits a captured image obtained through a viewer information input unit 110b (for example, a camera) of the content player 1b to the content player 1a via the network.

A communication controller 116a of the content player 1a receives the captured image via the network, the viewer recognition unit 111a of the content player 1a identifies the personal identification ID corresponding to the viewer based on the viewer database D1a and the captured image, the schedule manager 112a of the content player 1a reads out the schedule information corresponding to the identified personal identification ID based on the schedule database D2a, an additional information output controller 115a of the content player 1a outputs additional information based on the schedule information corresponding to the identified personal identification ID, and a system controller 106a of the content player 1a outputs a control signal controlling whether or not to continue the content play based on a continuous viewing flag contained in the schedule information corresponding to the identified personal identification ID. The communication controller 116a of the content player 1a outputs (transmits) the additional information and the control signal to the content player 1b via the network.

The communication controller 116b of the content player 1b receives the additional information and the control signal via the network. If the system controller 106b is controlling the content play (i.e., while playing the content), a display 109b of the content player 1b displays the additional information. The system controller 106a of the content player 1a furthermore controls the content play according to the control signal from the content player 1a. If it is the control signal not allowing continuous content play, for example, the system controller 106a of the content player 1a halts the content play.

By the above-described configuration, when the viewer is playing content on the content player 1b installed on the second floor, the content player 1a installed on the first floor can transmit the additional information corresponding to the viewer to the content player 1b installed on the second floor based on the viewer database D1a and the schedule database D2a and inform the viewer of the additional information. If a plurality of content players are connected with the network and one of the content players manages the viewer database D1a and the schedule database D2a, any content player can output (display) the additional information corresponding to the viewer.

The embodiments described above will be summarized below.

A content player according to the embodiments manages schedule information corresponding to a personal identification ID of a viewer, identifies the personal identification ID corresponding to the viewer from input information, controls output of schedule-related information based on the identified personal identification ID, and controls content output.

For example, if the content player identifies the viewer (personal identification ID) during content play, the content player outputs (displays/transmits) the schedule-related information contained in the schedule information corresponding to the identified personal identification ID at an output timing based on time information contained in the schedule information corresponding to the identified personal identification ID.

For example, if the viewer continues viewing content up to a planned time scheduled by the content player, the content player outputs information (time or scheduled item) related to the schedule and halts the content play. As shown above, the content player can display information related to the schedule to a user viewing content in a timely fashion.

By the above-described configuration, it becomes possible to assist children to go to school or to go to bed more effectively by interrupting the current content play or setting a viewing limit such that all content for children is not allowed to be played when a child is perceived as the viewer after a pre-registered time for children to go to school or to go to bed has passed. In this case, it is possible that the schedule information in a schedule database D2 of the content player 1 includes the viewing limit by which the content for children is not allowed to be played and a system controller 106, if it detects a category (for children) of the content being played, halts playing the content for children.

Moreover, it becomes possible that the content player 1 provides the viewers with more benefits such as preventing an umbrella or outfit for cold weather from being left behind when leaving home by taking in weather information and traffic information via data broadcasting or the like and outputting them together with a schedule notification.

The content player 1 can also notify a subject of the schedule of the schedule-related information at a pre-registered address of his/her information terminal if it decides that the subject of the schedule is not viewing the content.

The content player 1, if it detects there is no appropriate response (an operation to stop the content play or the like) from the viewer to a schedule notification, for example, the child continues watching TV ignoring the message “Time to do your homework”, can send a message to his/her parent to notify that the child continues watching TV.

All procedures of the above-described processing (for example, schedule notification) can be executed by software. Installing a program into a computer with computer-readable storage media containing the program to execute procedures of the above-described processing makes it possible to realize the above-described processing easily.

For example, the content player 1 can read in the above-described program from computer-readable storage media, store the read-in program, and complete an installation of the program.

The content player 1 can also download the above-described program through a communication controller 116 or the like and completes the installation of the program. With this process, the content player 1, which is equivalent to the above-described computer, can realize the above-described processing easily based on the above-described installed program.

The technical terms used above in relation to the embodiments and the names or technical terms described in the drawings are in no way restrictive. For example, the controller may be replaced with control means, a control unit, or a control module.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device, comprising:
a manager configured to manage a schedule corresponding to personal identification information;
an identifier configured to identify the personal identification information from input information; and
a controller configured to control output of schedule-related information relevant to the schedule corresponding to the identified personal identification information and output of content.

2. The electronic device of claim 1, wherein
the controller is configured to control an output timing of the schedule-related information based on time information contained in the schedule corresponding to the identified personal identification information.

3. The electronic device of claim 2, wherein
the controller is configured to output the schedule-related information at the output timing if the output timing comes during outputting the content.

4. The electronic device of claim 1, wherein
the controller is configured to output the schedule-related information with the content.

5. The electronic device of claim 1, wherein
the controller is configured to control content output based on content output control information which is set in the schedule corresponding to the identified personal identification information.

6. The electronic device of claim 5, wherein the controller is configured to halt the content output based on the content output control information.

7. The electronic device of claim 1, further comprising a display configured to display the content and the schedule-related information to be output.

8. The electronic device of claim 1, wherein
the identifier is configured to identify the personal identification information corresponding to a person who is recognized from a captured image to be input.

9. The electronic device of claim 1, wherein
the identifier is configured to identify the personal identification information corresponding to terminal identification information to be input.

10. The electronic device of claim 1, further comprising:
a receiver configured to receive weather information including date and time information and area information, wherein
the controller configured to control output of the related weather information based on the date and time information and the area information which are included in the schedule corresponding to the identified personal identification information.

11. The electronic device of claim 1, further comprising:
another receiver configured to receive traffic information including the date and time information and the area information, wherein
the controller configured to control output of the related traffic information based on the date and time information and the area information which are included in the schedule corresponding to the identified personal identification information.

12. The electronic device of claim 1, wherein
the manager is configured to manage the schedule corresponding to the personal identification information and an address of an information communication terminal, and
the controller is configured to transmit the schedule-related information to the address of the information communication terminal.

13. The electronic device of claim 12, wherein
the controller is configured to transmit the schedule-related information to the address of the information communication terminal if the personal identification information is unidentified.

14. The electronic device of claim 1, wherein
the identifier is configured to receive the input information input through an external device and transmitted from the external device and identifies the personal identification information from the received input information, and
the controller is configured to transmit the schedule-related information to the external device.

15. An information processing method, comprising:
managing a schedule corresponding to personal identification information;
identifying the personal identification information from input information; and
controlling output of schedule-related information of the schedule corresponding to the identified personal identification information and output of content.

16. An information processing method, which comprises:
a first electronic device managing a schedule corresponding to personal identification information;
a second electronic device connected to the first electronic device receiving input information and transmitting the input information to the first electronic device;
the first electronic device receiving the input information, identifying the personal identification information from the input information, and transmitting the second electronic device schedule-related information related to the schedule corresponding to the identified personal identification information; and
the second electronic device receiving the schedule-related information and outputting the received schedule-related information.

17. A computer usable program product comprising a computer usable storage medium including computer usable code for use in information processing, the computer usable program product comprising code for performing the steps of:
managing a schedule corresponding to personal identification information;
identifying the personal identification information from input information; and
controlling output of schedule-related information of the schedule corresponding to the identified personal identification information and output of content.
